(19) United States
(12) Patent Application Publication
(10) Pub. No.: US 2015/0285293 A1
(43) Pub. Date: Oct. 8, 2015

(54) ANTI-LOOSENING NUT

(71) Applicant: BESTMA CORPORATION, Tokyo (JP)

(72) Inventor: Kinichi KAWAKAMI, Tokyo (JP)

(21) Appl. No.: 14/450,631

(22) Filed: Aug. 4, 2014

Related U.S. Application Data
(63) Continuation-in-part of application No. 14/246,511, filed on Apr. 7, 2014.

(51) Int. Cl. F16B 39/12

(52) U.S. Cl. CPC F16B 39/12

(57) ABSTRACT

The nut is usually fixed by the axial force generated with the bolt fastening. However, the loosening force, which is larger than the axial stress, acts on the nut by the repetitive vibration or shock, whereby the loosening phenomenon of the nut generates. So it is necessary to prevent the loosening, the present invention threads an outer screw as the direction of an inner screw of the nut on an outer periphery of the flange or the shank of nut and screws together an lock nut with the flange or the shank. In doing so, it is possible to constantly prevent the loosening of the nut.

### CROSS REFERENCE TO RELATED APPLICATION

This is a continuation-in-part of U.S. patent application Ser. No.14/246,511 filed Apr. 7, 2014 (now abandoned).

### BACKGROUND OF THE INVENTION

1. Field of the Invention

The present invention relates to a nut corresponding to a bolt used in cases of connecting between parts of machines or constructions or of connecting a main body and a part of machines or constructions, in particular to an anti-loosening nut, which has no loose, having a flange or a shank on a nut portion and comprising a structure that a lock nut having round, hexagonal, or other shape is threadably mounted on the flange or the shank.

2. Description of the Related Art

Heretofore, the bolt and the nut used for fastenings of the parts of machine components or the constructions raise the problem that the fastening force decreases because the nut is loosened by vibration or impulsion. As the provision, there are a double-nut method adding another nut for anti-loosening, a method using a specially-shaped washer, and so on.

Thus far, such the anti-loosening mechanism is the method whether mediating an anti-rotating mechanism at an intermediate port between the nut and a contact bearing surface or anti-loosening with combinatorial nut using a wedge mechanism, except for the double-nut method. However, these methods are rather the indirect methods in a manner than the methods for directly blocking or preventing the nut loosening.

### SUMMARY OF THE INVENTION

The present invention has been developed in view of the above-described circumstances, and an object of the present invention is to provide the anti-loosening nut for constantly blocking or preventing the phenomenon that the nut is loosened by the repetitive vibration and so on.

The aspect of the present invention is to be able to capture a loosening operation of the nut as an anti-operation of the anti-loosening under generating an axial force. What the nut loosens after the bolt fastening means that the nut rotates in the reverse direction against the tension by any operations. Then, if the lock nut rotates in the direction for preventing the reverse rotation, it is possible to certainly prevent the nut loosening because the supplemental function between the nut and a lock nut mounted on the nut is constantly completed.

The present invention is a nut having a flange or a shank and the structure that the outer screw having the same direction as the inner screw of the nut is threaded on the outer periphery of the flange or the shank, and the lock nut for anti-loosening is screwed with the outer screw of the outer periphery of the flange or the shank.

### BRIEF DESCRIPTION OF THE DRAWINGS

In the accompanying drawings:

FIG. 1 is showing a plane view of a nut of the present invention;

FIG. 2 is showing a side view of the nut (shown in FIG. 1) of the present invention;

FIG. 3 is showing a plane view of a lock-nut (round type) of the present invention;

FIG. 4 is showing a side view of the lock-nut (shown in FIG. 3) of the present invention;

FIG. 5 is showing a plane view of an anti-loosening nut of the present invention;

FIG. 6 is showing a side view of the anti-loosening nut (shown in FIG. 5) of the present invention;

FIG. 7 is showing a perspective view of the anti-loosening nut (shown in FIGS. 5 and 6) of the present invention;

FIG. 8 is showing a plane view of a nut of a second embodiment of the present invention;

FIG. 9 is showing a side view of the nut (shown in FIG. 8) of the present invention;

FIG. 10 is showing a plane view of a lock-nut (round type) of the second embodiment of the present invention;

FIG. 11 is showing a side view of the lock-nut (shown in FIG. 10) of the present invention;

FIG. 12 is showing a plane view of an anti-loosening nut of the second embodiment of the present invention;

FIG. 13 is showing a side view of the anti-loosening nut (shown in FIG. 12) of the present invention; and

FIG. 14 is showing a perspective view of the anti-loosening nut (shown in FIGS. 12 and 13) of the present invention.

### DESCRIPTION OF THE PREFERRED EMBODIMENT

Usually, in case of fastening, for example, of machine or construction, or the fastening between tubes or the machine and the tube, it is general to use the bolt and nut. In these fastenings, by extending the bolt with fastening the nut, two targets are fastened by using the generating stress. However, in case of the targets having vibration or shock, the nut is loosened by the repetition behaviors.

To block or prevent this loosening phenomenon, an anti-loosening nut of the present invention has following structure. That is, the present invention is a nut having a flange or a shank and the structure that the outer screw having the same direction as an inner screw of the nut is threaded on an outer periphery of the flange or the shank, and a lock nut for anti-loosening is screwed with the outer screw of the outer periphery of the flange or the shank.

Hereinafter, embodiments of the present invention will be described in detail with reference to the accompanying drawings.

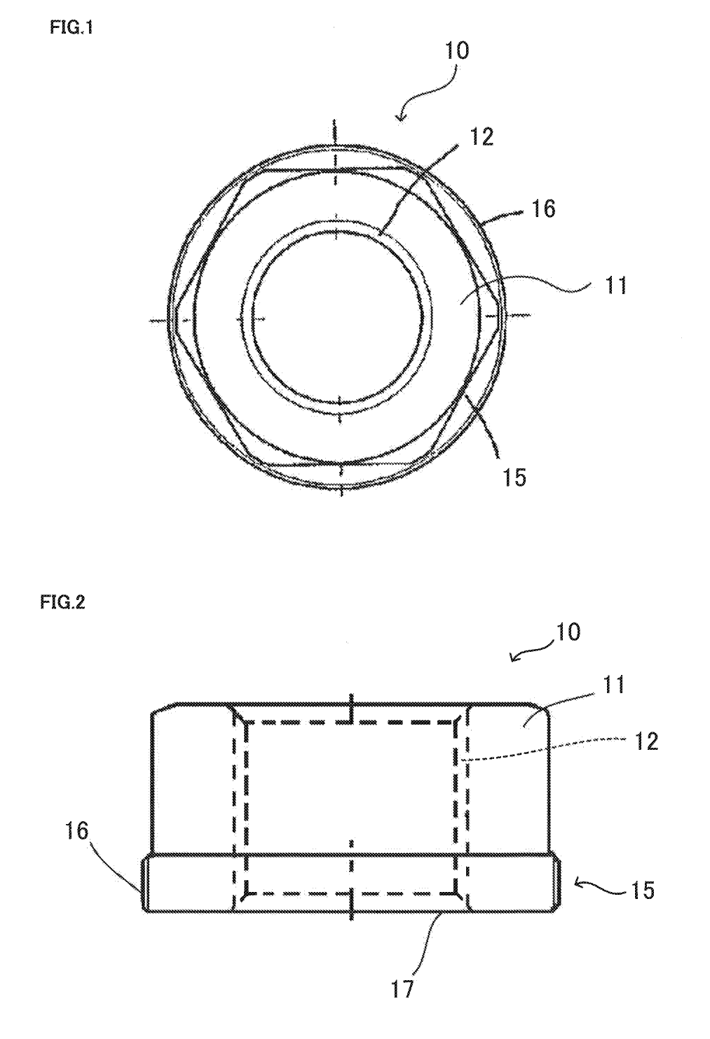

A nut 10 of the present invention has a structure shown in FIG. 1 and FIG. 2, and comprises a disk-shaped flange (or shank) 15 on a lower part of a nut main body 11. A inner face of the nut 10 is cylindrical shape screwing together a bolt (not shown), an inner screw (female screw) 12 screwing together the bolt is threaded in the inner periphery, and an outer screw (male screw) 16 in the same direction as the inner screw (female screw) 12 in the inner periphery is threaded in the outer periphery of the flange (or shank) 15. A contact bearing surface 17 of the nut 10 is identical surface to the bottom of the flange (or shank) 15.

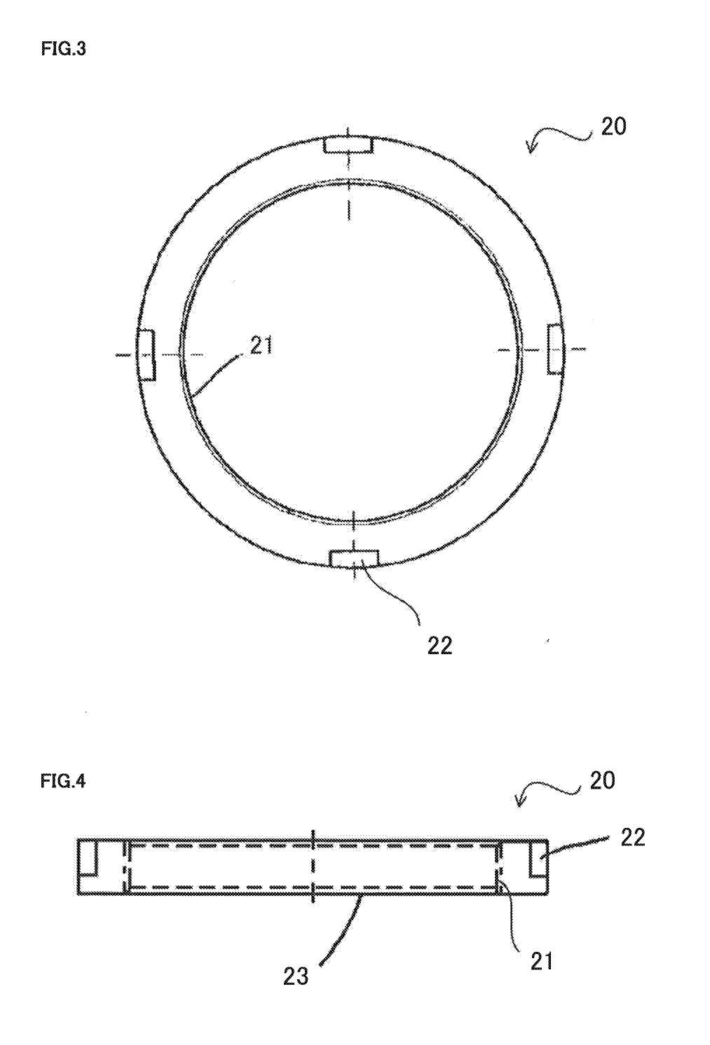

Moreover, a lock nut 20 of the present invention is an annular (or hexagonal or the other structure) structure shown in FIG. 3 and FIG. 4, an inner screw (female screw) 21 screwing together the outer screw 16 of the outer periphery of the flange 15 is threaded in the inner periphery, and a notch part 22 for using as fastening the lock nut 20 is arranged in, for example, four places. The number of the notch part 22 is arbitrarily.

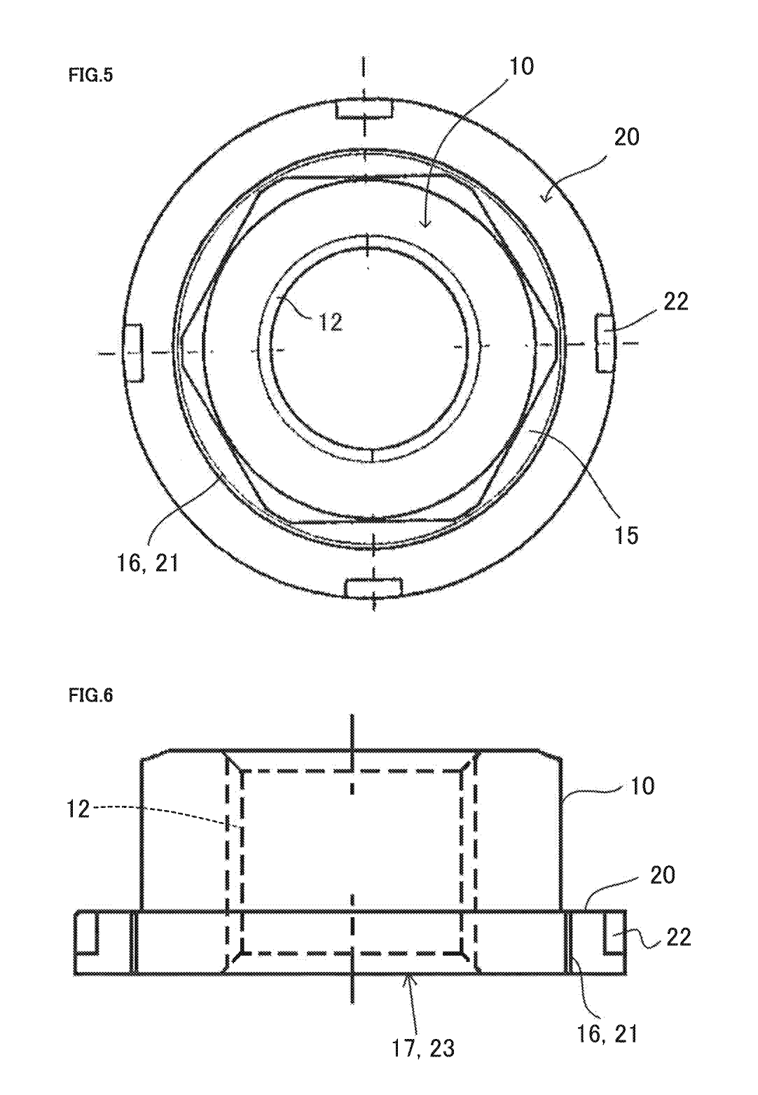

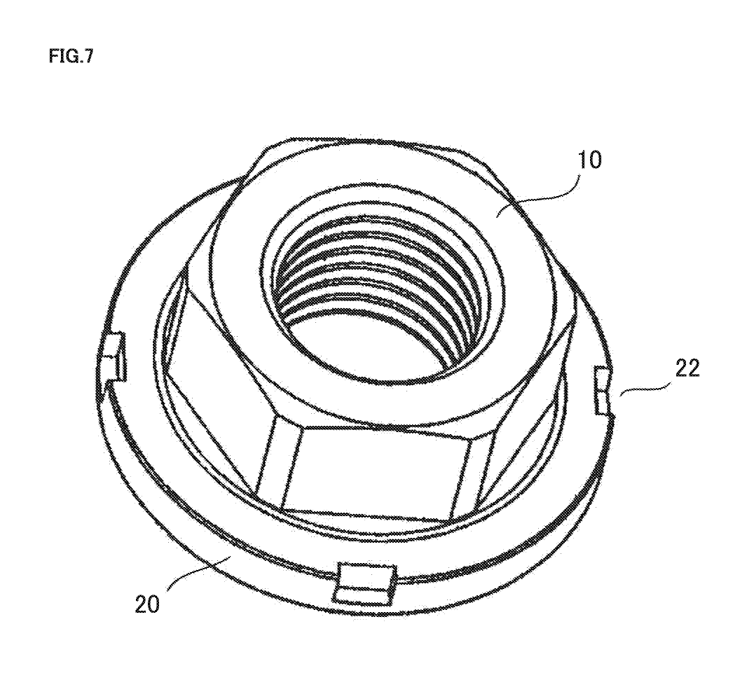

The fastening of the target is done by the same method of the general fastening nut with using the nut 10 and the lock nut 20. FIG. 5 is showing a plan view of the state that the nut 10 and the lock nut 20 are fastened to the bolt, FIG. 6 is showing the side view of said state, and FIG. 7 is showing the perspective view of said state. In the perspective view, the fastened bolt is abbreviated.

The great difference from the general fastening nut is that the outer screw 16 is threaded in the same direction as the inner screw 12 of the nut 10 to the outer periphery of the flange (or shank) 15 of the lower part of the nut 10.

Here is a method for mounting the nut 10 to the bolt. That is, the method comprises the steps of: making the lock nut 20 more slightly than the bottom 17 of the flange 15 of the nut or detaching the lock nut 20 (in case shank raises to the top end) before attaching; fastening the nut 10 to the bolt in a predetermined torque; inserting the lock nut 20 to the outer screw 16 of the nut 10 after fastening by the nut 10; and fastening the lock nut 20 in the predetermined torque. Then, the method further comprises the step of: putting a contact surface 23 of the lock nut 20 on a bearing surface of the fastening target; hitching a manual or grapping wrench to the notch part 22; and fixing the contact surface 23 of the lock nut 20 on the bearing surface of the fastening target.

After fastening by the nut 10 and the lock nut 20, the lock nut 20 rotates in the fastening direction with the correlative relationship between the bolt and the nut when the nut 10 of which the axial stress generates in the bolt makes to rotate in the loosening direction with the vibration or shock. In other words, the fastening direction of the nut is relatively the direction rotating in the reverse (loosening) direction, the lock nut 20 prevents the loosening of the nut 10 with necessarily rotating in the fastening direction. The larger the torque that the nut 10 loosens is, the more growing the stress relative to the bearing surface of the lock nut 20 is, whereby the loosening of the nut 10 is blocked. As a result, the lock nut 20 certainly blocks the loosening of the bolt and nut.

Moreover, because a friction resistance between the bearing surfaces of the lock nut 20 is larger than a friction between screws of the bolt and nut, the above correlative relationship constantly comes into existence while no loosening is only ahead of the lock nut 20. Hereinafter, the reason will be explained.

The following Formula 1 comes into power between the torque (rotation moment) T for adding to the bolt and nut and the axial force (axial stress) N.

### Formula 1

T=k·d·N

where, k is torque coefficient, and d is nominal diameter of the bolt.

Moreover, the torque coefficient k is showing in the following Formula 2.

### Formula 2

K=½d(d₂(μ₀/cos30°+tanβ)+μ·dn)

where, tang equals to P/πd, P is screw pitch, d₂ is effective diameter of the bolt, μ₀ is friction coefficient between the bolt and the nut, μ is friction coefficient of the contact bearing surface 17 of the nut 10, and do is the effective diameter of the nut 10.

In the above Formula 2, cos30° is usually a half of the screw thread of the bolt (60°), μ₀/cos30° is a friction between screws. Moreover, if applying the lubricant, the friction coefficient between the bolt and the nut μ₀ can decrease to about 0.08.

On the other hand, the friction coefficient μ of the contact bearing surface 17 of the nut 10 is usually 0.2 or more, whereby the following Formula 3 constantly comes into power between the friction μ·dn between bearing surfaces and the friction μ₀/cos30°, between screws.

### Formula 3

μ·dn>μ₀/cos30°

μ·dn of Formula 3 corresponds to the friction resistance of the lock nut 20, therefore, if it is larger than the friction resistance of the contact bottom of the nut 10, the lock nut 20 does not separately circle ahead of the nut 10 (or bolt).

Next, a second embodiment of the present invention will be described in detail with reference to the accompanying drawings.

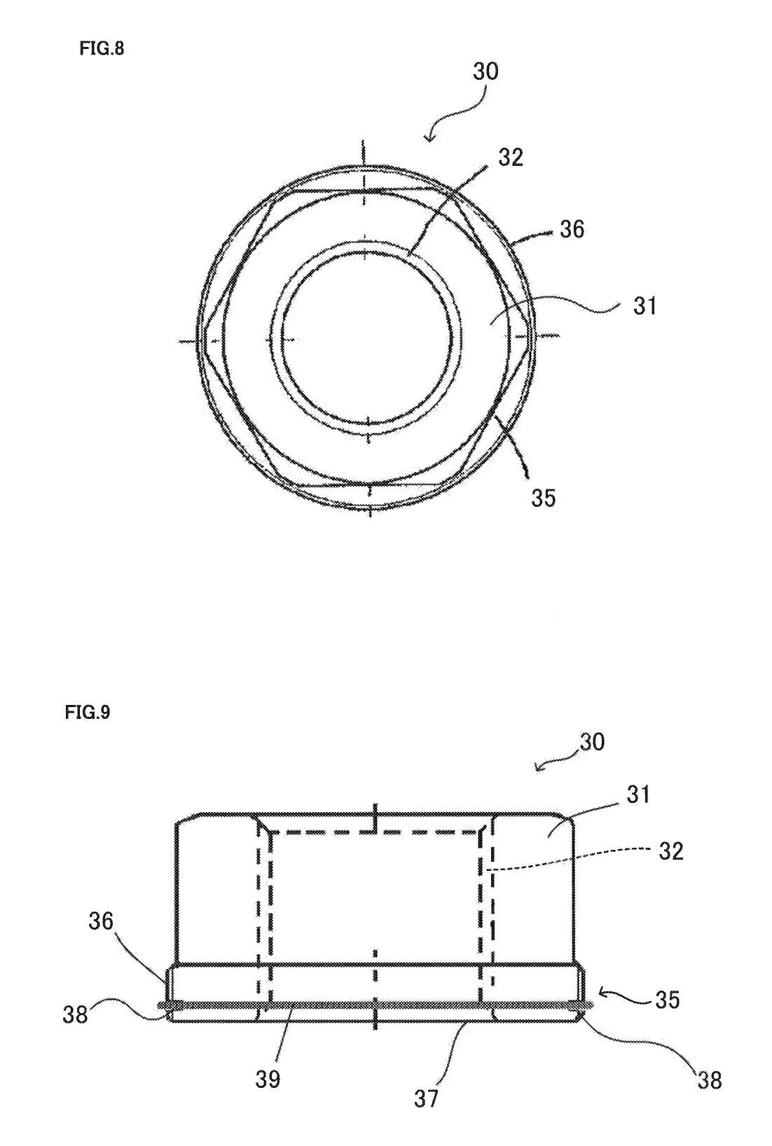

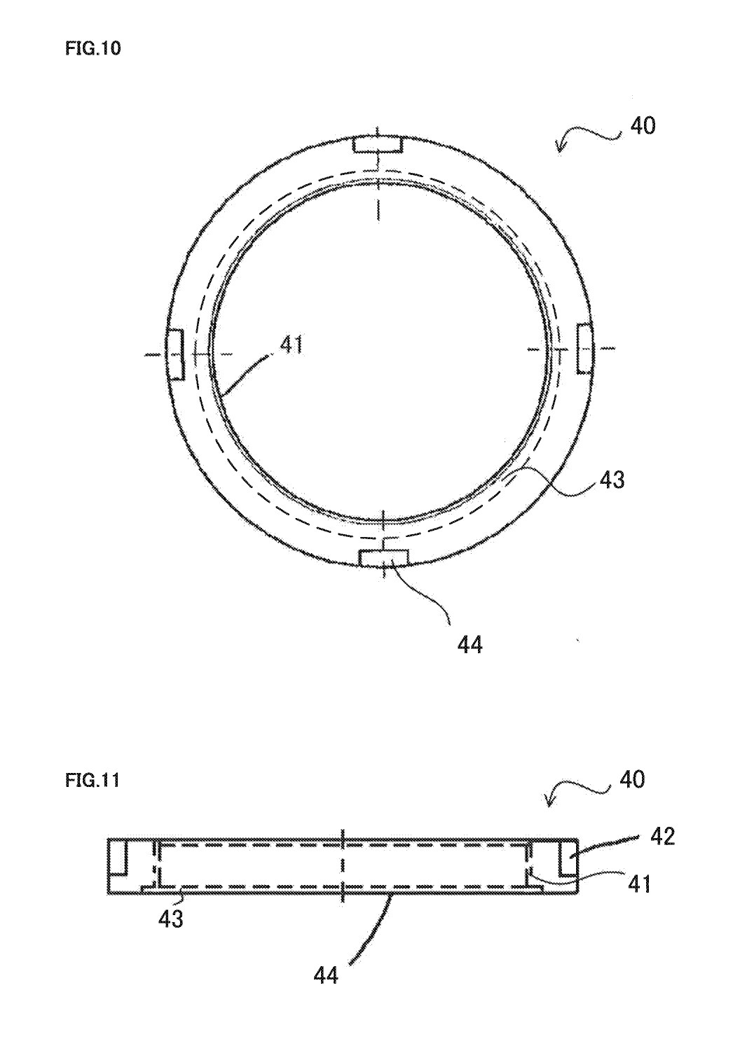

A nut 30 of the present invention has a structure shown in FIG. 8 and FIG. 9, and comprises a disk-shaped flange (or shank) 35 on a lower part of a nut main body 31. A inner face of the nut 30 is cylindrical shape screwing together a bolt (not shown), an inner screw (female screw) 32 screwing together the bolt is threaded in the inner periphery, and an outer screw (male screw) 36 in the same direction as the inner screw (female screw) 32 in the inner periphery is threaded in the outer periphery of the flange (or shank) 35. A contact bearing surface 37 of the nut 30 is identical surface to the bottom of the flange (or shank) 35. Here, in the second embodiment of the present invention, a groove 38 for a snap ring 39 is mounted on a side of the outer screw (male screw) 36. Here, in the second embodiment of the present invention, the nut 30 is connected with a lock nut 40 (shown in FIG. 10 and FIG. 11) by inserting the snap ring 39 into the grooves 38 after fitting the lock nut 40 into the nut 30. Herewith, because the snap ring 39 runs into a groove ceiling of the lock nut 40 while both (the nut 30 and the lock nut 40) rotation angles are within 30°, each (the nut 30 or the lock nut 40) does not loosen (rotate) by itself with firmly maintaining a primary correlation between the bolt and nut. Moreover, the snap ring 39 is selected from spiral retaining ring, seal ring, and so on.

Moreover, the lock nut 40 of the present invention is an annular (or hexagonal or the other structure) structure shown in FIG. 10 and FIG. 11, an inner screw (female screw) 41 screwing together the outer screw 36 of the outer periphery of the flange 35 is threaded in the inner periphery, and a notch part 42 for using as fastening the lock nut 40 is arranged in, for example, four places. The number of the notch part 42 is arbitrarily. Moreover, a round groove 43 is mounted in a bottom of said inner screw 41. As well, the round groove 43 is provided by heretofore method.

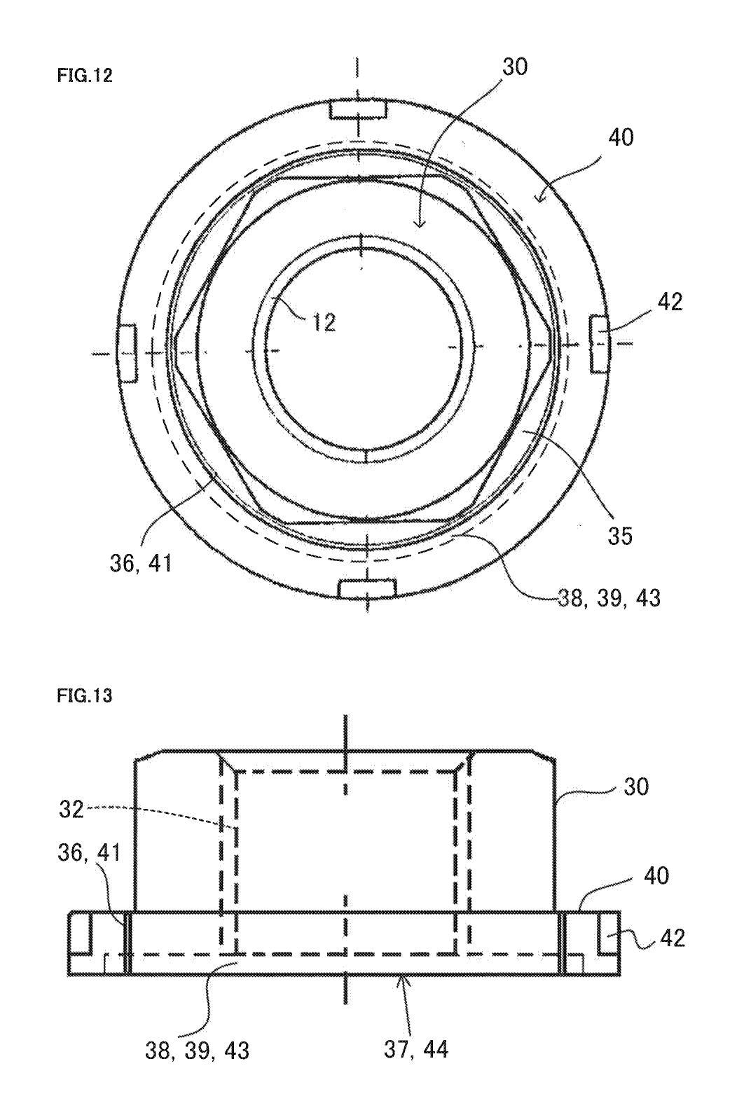

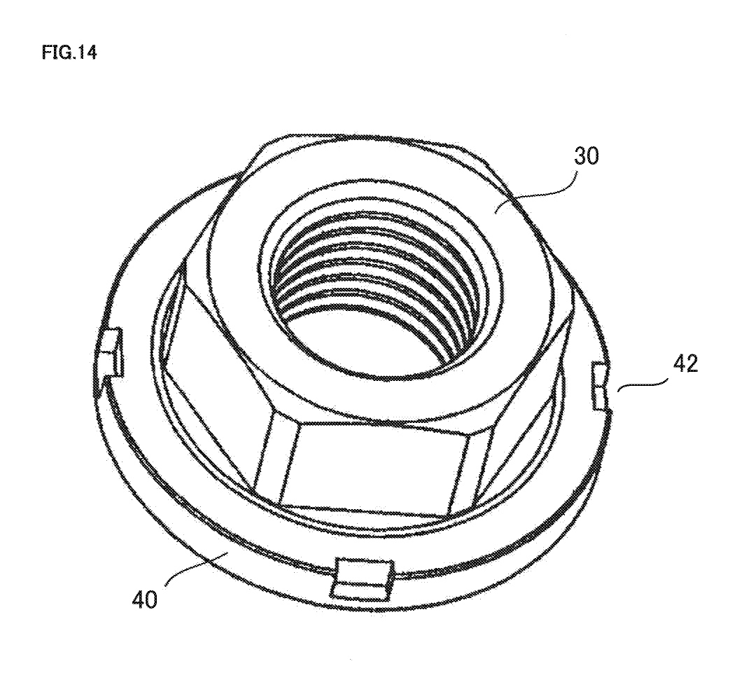

The fastening of the target is done by the same method of the general fastening nut with using the nut 30 and the lock nut 40. FIG. 12 is showing a plan view of the state that the nut 30 and the lock nut 40 are fastened to the bolt, FIG. 13 is showing the side view of said state, and FIG. 14 is showing the perspective view of said state. In the perspective view, the fastened bolt is abbreviated.

The great difference from the general fastening nut is that the outer screw 36 is threaded in the same direction as the inner screw 32 of the nut 30 to the outer periphery of the flange (or shank) 35 of the lower part of the nut 30.

Here is a method for mounting the nut 30 to the bolt. That is, the method comprises steps of: making the lock nut 40 more slightly than the bottom 37 of the flange 35 of the nut or detaching the lock nut 40 (in case shank raises to the top end) before attaching; fastening the nut 30 to the bolt in a predetermined torque; inserting the lock nut 40 to the outer screw 36 of the nut 30 after fastening by the nut 30; and fastening the lock nut 40 in the predetermined torque. When the step of making or detaching the lock nut 40, while the snap ring 39 fitting together the grooves 38. Moreover, when the steps of inserting and fastening, the round groove 43 is fitted on the snap ring 39 fitting together the grooves 38.

Then, the method further comprises the step of: putting a contact surface 44 of the lock nut 40 on a bearing surface of the fastening target; hitching a manual or grapping wrench to the notch part 42; and fixing the contact surface 44 of the lock nut 40 on the bearing surface of the fastening target.

After fastening by the nut 30 and the lock nut 40, the lock nut 40 rotates in the fastening direction with the correlative relationship between the bolt and the nut when the nut 30 of which the axial stress generates in the bolt makes to rotate in the loosening direction with the vibration or shock. In other words, the fastening direction of the nut is relatively the direction rotating in the reverse (loosening) direction, the lock nut 40 prevents the loosening of the nut 30 with necessarily rotating in the fastening direction. The larger the torque that the nut 30 loosens is, the more growing the stress relative to the bearing surface of the lock nut 40 is, whereby the loosening of the nut 30 is blocked. As a result, the lock nut 40 certainly blocks the loosening of the bolt and nut.

Moreover, because a friction resistance between the bearing surfaces of the lock nut 40 is larger than a friction between screws of the bolt and nut, the above correlative relationship constantly comes into existence while no loosening is only ahead of the lock nut 40.

Hereinbefore, the embodiments of the present invention have been particularly explained, however, the present invention is not limited by these embodiments, but is arbitrarily mutable in the range not varying the general meaning.

What is claimed is:

1. An anti-loosening nut, in a nut having a flange or a shank, an outer screw in the same direction as an inner screw of said nut is threaded on an outer periphery of said flange or said shank, wherein a lock nut for the purpose of anti-loosening is threadably mounted on said flange or said shank.

2. The anti-loosening nut according to claim 1, wherein an inner screw of said lock nut is threadably mounted on an outer screw of said flange or said shank.

3. The anti-loosening nut according to claim 1, wherein said inner screw of said nut is a female screw, and wherein said outer screw of said flange is a male screw.

4. An anti-loosening nut, in a nut having a flange or a shank, an outer screw in the same direction as an inner screw of said nut is threaded on an outer periphery of said flange or said shank, wherein a lock nut for the purpose of anti-loosening is threadably mounted on said flange or said shank, wherein a groove for a snap ring is mounted on a side of said outer screw, wherein said nut is connected with the lock nut by inserting said snap ring into said grooves after fitting said lock nut into said nut, wherein said snap ring runs into a groove ceiling of said lock nut while both (said nut and said lock nut) rotation angles are within 30°, and wherein each does not loosen (rotate) by itself with firmly maintaining a primary correlation between said bolt and said nut.

5. The anti-loosening nut according to claim 4, wherein an inner screw of said lock nut is threadably mounted on an outer screw of said flange or said shank, and wherein a round groove is mounted in a bottom of said inner screw.

6. The anti-loosening nut according to claim 4, wherein said inner screw of said nut is a female screw, and wherein said outer screw of said flange is a male screw.
